(19) United States
(12) Patent Application Publication
(10) Pub. No.: US 2025/0133555 A1
(43) Pub. Date: Apr. 24, 2025

(54) TERMINAL, COMMUNICATION METHOD, AND RADIO COMMUNICATION SYSTEM

(71) Applicant: NIPPON TELEGRAPH AND TELEPHONE CORPORATION, Tokyo (JP)

(72) Inventors: Yoghitha RAMAMOORTHI, Tokyo (JP); Riku OMIYA, Tokyo (JP); Masashi IWABUCHI, Tokyo (JP); Tomoaki OGAWA, Tokyo (JP); Yasushi TAKATORI, Tokyo (JP)

(21) Appl. No.: 18/835,215

(22) PCT Filed: Feb. 21, 2022
(86) PCT No.: PCT/JP2022/006990

§ 371 Date: Aug. 1, 2024

(51) Int. Cl. H04W 72/12

(52) U.S. Cl. CPC H04W 72/12

(57) ABSTRACT

A terminal includes a receiver that receives a first downlink signal from the first base station and a second downlink signal from the second base station; a transmitter that transmits a first uplink signal to the first base station and a second uplink signal to the second base station; and a processor that establishes a downlink connection with the first base station and an uplink connection with the second base station, in response to detecting a UL-DL imbalance, wherein, upon detecting that an instruction signal from the second base station is received, the processor changes the uplink connection with the second base station to an uplink connection with the second base station via a relay device.

### TECHNICAL FIELD

The present invention relates to a terminal and a communication method in a radio communication system.

### BACKGROUND ART

In a fifth-generation mobile communication system (5G (Above-6 GHz)), a high-frequency band called a millimeter-wave band is used, in addition to a conventional frequency band. In general, a radio wave in a high-frequency band called Above-6, such as the 28 GHz band available in 5G or local 5G, can be significantly attenuated depending on a propagation distance. Accordingly, long-distance transmission is achieved by using ultra-high-gain beam-forming transmission technology.

### CITATION LIST

### Patent Literature

[PL 1] U.S. Pat. No. 9,620,862

### Non Patent Literature

[NPL 1] W. Tang et al., “Wireless Communications With Reconfigurable Intelligent Surface: Path Loss Modeling and Experimental Measurement,” in IEEE Transactions on Wireless Communications, vol. 20, no. 1, pp. 421-439, January 2021.
[NPL 2] Y. Ramamoorthi and A. Kumar, “Dynamic Time Division Duplexing for Downlink/Uplink Decoupled Millimeter Wave-Based Cellular Networks,” in IEEE Communications Letters, vol. 23, no. 8, pp. 1441-1445 August 2019
[NPL 3] S. Singh, X. Zhang, and J. G. Andrews, “Joint rate and SINR coverage analysis for decoupled uplink-downlink biased cell associations in HetNets,” IEEE Trans. Wireless Commun., vol. 14, no. 10, pp. 5360-5373 October 2015.
[NPL 4] 3GPP, Technical Specification Group Radio Access Network; Evolved Universal Terrestrial Radio Access (E-UTRA) and NR; Multi-connectivity;, Tech. Rep. TR 37.740 v16.5.0, 2021.

### SUMMARY OF INVENTION

### Technical Problem

Here, a situation is assumed where a downlink/uplink decoupling (DUDe: downlink and uplink decoupling) method for decoupling Uplink (UL) and Downlink (DL) is applied to a space in which a large shield moves quasi-statically or dynamically.

In this case, a radio wave in the above-described high frequency band tends to travel linearly, so that the loss caused by the shield tends to increase. Accordingly, there is a need for enhancing uplink transmission capability from a terminal.

The present invention has been accomplished in view of the above-described point, and an object is to enhance uplink transmission capability from a terminal.

### Solution to Problem

According to an aspect of the present invention, there is provided a terminal for communicating with a first base station and a second base station, the terminal including a receiver that receives a first downlink signal from the first base station and a second downlink signal from the second base station; a transmitter that transmits a first uplink signal to the first base station and a second uplink signal to the second base station; and a processor that establishes a downlink connection with the first base station and an uplink connection with the second base station, in response to detecting that first received power of the first downlink signal in the terminal is higher than second received power of the second downlink signal in the terminal, and that third received power of the first uplink signal in the first base station is lower than or equal to fourth received power of the second uplink signal in the second base station, wherein, upon detecting that the receiver receives an instruction signal from the second base station, the processor changes the uplink connection with the second base station to an uplink connection with the second base station via a relay device.

### ADVANTAGEOUS EFFECTS OF INVENTION

According to an embodiment, uplink transmission capability of a terminal can be enhanced.

### BRIEF DESCRIPTION OF DRAWINGS

FIG. 1 is a diagram illustrating an example of a configuration of a radio communication system.

FIG. 2 is a diagram illustrating an example of a functional configuration of a base station.

FIG. 3 is a diagram illustrating an example of a functional configuration of a terminal.

FIG. 4 is a diagram illustrating an example of a functional configuration of a Reconfigurable Intelligent Surface (RIS).

FIG. 5 is a diagram illustrating an example of a plurality of elements included in the RIS.

FIG. 6 is a diagram illustrating an example of a hardware configuration of each of the base station, the terminal, and the RIS.

FIG. 7 is a diagram illustrating an example of UL-DL imbalance.

FIG. 8 is a diagram illustrating an example of DUDe.

FIG. 9 is a diagram illustrating an example in which the RIS is applied to UL of the DUDe.

FIG. 10 is a diagram illustrating an example of UL performance in a case where the RIS is applied to UL of the DUDe.

FIG. 11 is a diagram illustrating an example in which the RIS is applied to UL of the DUDe.

FIG. 12 is a flowchart illustrating an example of a procedure in the radio communication system.

### DESCRIPTION OF EMBODIMENTS

A Reconfigurable Intelligent Surface (RIS) has been considered as an effective way of controlling channel by properly tuning a phase and an amplitude of an electromagnetic signal. According to recent studies and experiments, various architectures and multiple access technologies have been proposed.

Given multi-connectivity is inevitable in future heterogeneous networks, it is important to consider the user's connectivity with more than one transmission point (TPs). One such method which compensates for transmit power imbalance that occurs due to difference in transmit power of deployed BSs is splitting of uplink (UL) and downlink (DL) association. This is termed as UL/DL split by the standard and later evolved as downlink/uplink decoupling (DUDe).

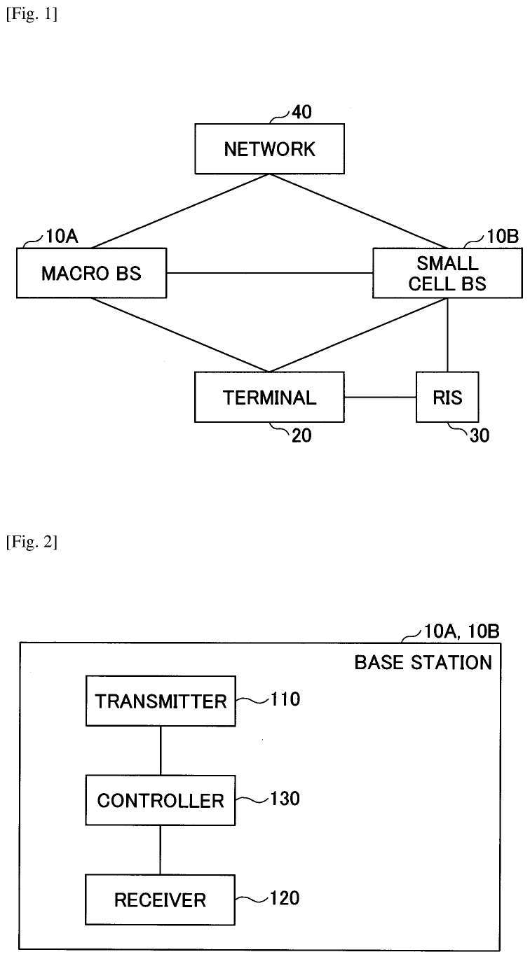

In the following, embodiments of the present invention are described based on the drawings. FIG. 1 is a diagram illustrating an example of a configuration of a radio communication system. As illustrated in FIG. 1, the radio communication system includes a macro cell base station 10A; a small cell base station 10B; a terminal 20; a Reconfigurable Intelligent Surface (RIS) 30; a network 40; and the like. The macro base station 10A and the small cell base station 10B are connected to the network 40 by wire of radio. The macro cell base station 10A and the small cell base station 10B are communicatively connected, for example, via an X2 interface. The small cell base station 10B and the RIS 30 are communicatively connected by wire or radio. In the example of FIG. 1, the RIS 30 is assumed to be connected to the small cell base station 10B. However, the embodiments of the present invention is not limited to this example. For example, the RIS 30 may be connected to the macro cell base station 10A. Each of the macro cell base station 10A, the small cell base station 10B, and the terminal 20 is capable of performing transmission and reception of signals by applying beam forming.

The macro cell base station 10A is a base station that forms a wide communication area in an outdoor area or the like. The macro cell base station 10A may be referred to as a high power base station. The macro cell base station 10A provides high-speed, large-capacity radio communication with the terminal 20, for example, by transmitting and receiving radio waves in a high frequency band used in the fifth generation mobile communication system (5G). The small cell base station 10B is a base station that forms a narrow communication area in an indoor area or the like. The small cell base station 10B may be referred to as a low power base station. The small cell base station 10B provides high-speed radio communication with the terminal 20, for example, by transmitting and receiving radio waves in the high frequency band used in the 5G. The terminal 20 is, for example, a communication device, such as a smartphone, a tablet terminal, or a Personal Computer (PC).

The terminal 20 can communicate simultaneously with the macro cell base station 10A and the small cell base station 10B by configuring dual connectivity between the macro cell base station 10A and the small cell base station 10B. For communicating with the terminal 20, the small cell base station 10B may communicate through the RIS 30, as a relay device. In the example of FIG. 1, it is assumed that the RIS 30 relays communication between the small cell base station 10B and the terminal 20. However, the embodiments of the present invention is not limited to this example. For example, the RIS 30 may relay communication between the macro cell base station 10A and the terminal 20.

The RIS 30 is connected, by wire or radio, to the small cell base station 10B (which may be connected to the macro cell base station 10A). The RIS 30 may relay a signal from the terminal 20 to the small cell base station 10B by changing the reflection direction of a carrier wave by which the signal from the terminal 20 is carried in accordance with configuration information from the small cell base station 10B.

In FIG. 1, one macro cell base station 10A, one small cell base station 10B, one terminal 20, and one RIS 30 are illustrated. However, the embodiments of the present invention is not limited to this example. The radio communication system may include one or more macro cell base stations 10A, one or more small cell base stations 10B, one or more terminals 20, and one or more RISs 30.

FIG. 2 is a diagram illustrating an example of a functional configuration of each of the macro cell base station 10A and the small cell base station 10B. As illustrated in FIG. 2, each of the macro cell base station 10A and the small cell base station 10B includes a transmitter 110; a receiver 120; and a controller 130. The functional configuration illustrated in FIG. 2 is only an example. The functional division and the names of the functional units may be any division and any names, provided that an operation according to the embodiments can be executed.

The transmitter 110 creates a transmission signal from transmission data and wirelessly transmits the transmission signal. The receiver 120 receives various signals wirelessly and obtains higher layer signals from the received physical layer signals. The receiver 120 includes a measuring unit that measures a received signal and obtains received power.

The controller 130 controls the base station (the macro cell base station 10A or the small cell base station 10B). The function of the controller 130 related to transmission may be included in the transmitter 110, and the function of the controller 130 related to reception may be included in the receiver 120.

FIG. 3 is a diagram illustrating an example of a functional configuration of the terminal 20. As illustrated in FIG. 3, the terminal 20 includes a transmitter 210, a receiver 220, and a controller 230. The functional configuration illustrated in FIG. 3 is only an example. The functional division and the names of the functional units may be any division and any names, provided that an operation according to the embodiments can be executed.

The transmitter 210 includes a function for creating a signal to be transmitted to a base station (a macro cell base station 10A and/or a small cell base station 10B) and transmitting the signal wirelessly. The receiver 220 includes a function for receiving various signals transmitted from a base station (a macro cell base station 10A and/or a small cell base station 10B) and obtaining, for example, information of a higher layer from the received signals. The receiver 220 includes a measuring unit that measures a received signal and obtains received power.

The controller 230 controls the terminal 20. The function of the controller 230 related to transmission may be included in the transmitter 210, and the function of the controller 230 related to reception may be included in the receiver 220.

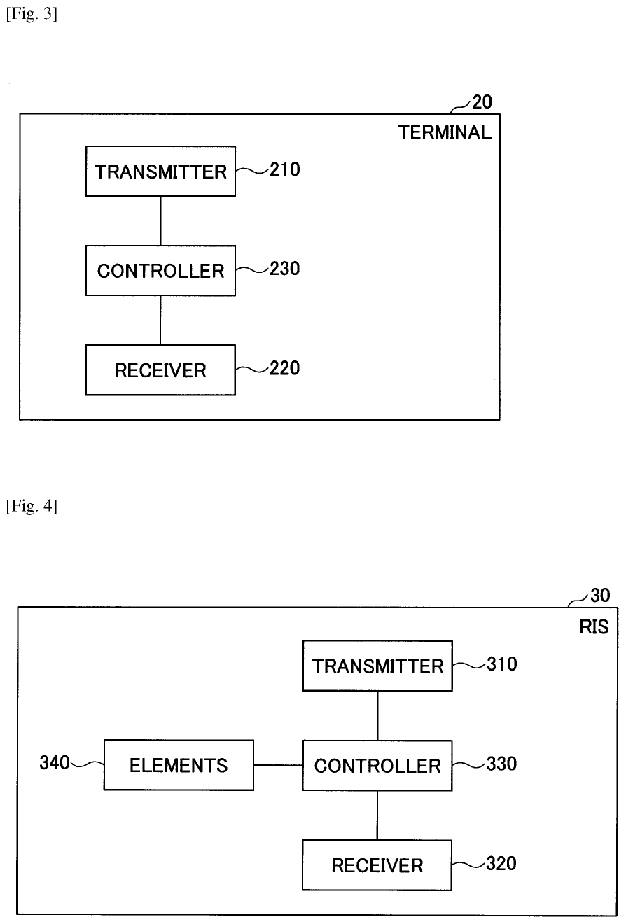

FIG. 4 is a diagram illustrating an example of a functional configuration of the RIS 30. As illustrated in FIG. 4, the RIS 30 includes a transmitter 310, a receiver 320, a controller 330, and a plurality of elements 340. The functional configuration illustrated in FIG. 4 is only an example. The functional division and the names of the functional units may be any division and any names, provided that an operation according to the embodiments can be executed.

The transmitter 310 includes a function for generating a signal to be transmitted to a base station (the macro cell base station 10A and/or small cell base station 10B) and transmitting a signal by wire and/or radio. The receiver 320 includes a function for receiving various signals transmitted from a base station (a macro cell base station 10A and/or a small cell base station 10B) and obtaining, for example, information of a higher layer from the received signals.

The controller 330 controls the RIS 30. The plurality of elements 340 includes a function for changing a reflection direction of a carrier wave by which a signal from the terminal 20 is carried. The controller 330 has a function to control a reflection phase (or a reflection direction) of a wave reflected by each element 340 of the plurality of elements 340 in response to an indication signal from the small cell base station. For example, the controller 330 controls a reflection phase (or a reflection direction) of a reflected wave by controlling impedance, spacing, and/or an orientation of each element 340 of the plurality of elements 340.

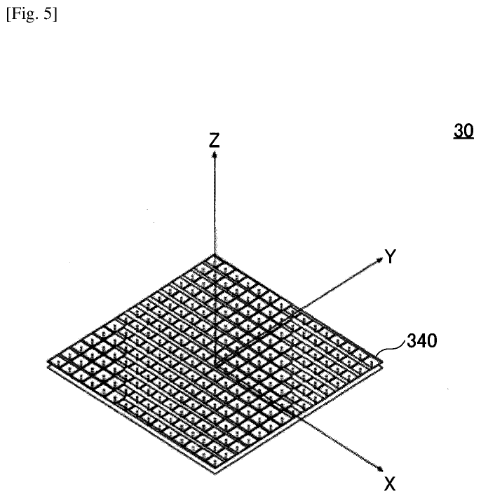

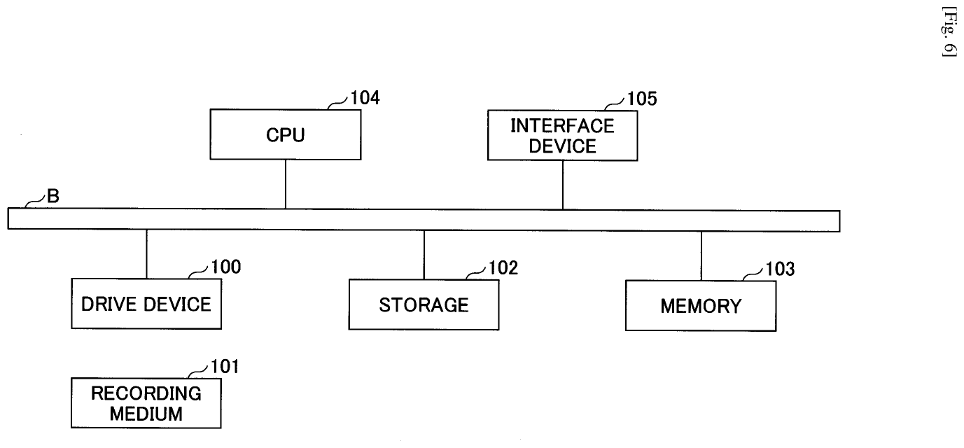

The plurality of elements 340 may be configured, for example, as a reflect array. FIG. 5 is a diagram illustrating an example of the plurality of elements 340 as a reflect array. When the plurality of elements 340 are configured as a reflect array, for example, a travelling direction of a reflected wave can be changed by changing a reflection phase of the reflected wave by changing element spacing of the plurality of elements 340. Note that the method of changing the reflection phase of the reflected wave is not limited to changing the element spacing, and the reflection phase of the reflected wave can be changed by changing the impedance of each element 340 of the plurality of elements 340. Additionally or alternatively, a reflection direction of a reflected wave may be changed by including, in each element 340 of the plurality of elements 340, a reflection element for changing the reflection direction of an incident wave, and by changing an orientation of the reflection element. For example, the reflection element may include an actuator utilizing Micro Electro Mechanical Systems (MEMS), and a reflection direction of a reflected wave may be controlled by controlling a voltage applied to a piezoelectric material forming the actuator.

FIGS. 2-4 illustrate blocks of functional units. These functional blocks (components) are implemented by any combination of hardware and/or software. The implementation method of each functional block is not particularly limited. That is, each functional block may be implemented by using a single device that is physically or logically combined, these devices may be implemented by directly or indirectly connecting (e.g., by using wire or radio) two or more devices that are physically or logically separated.

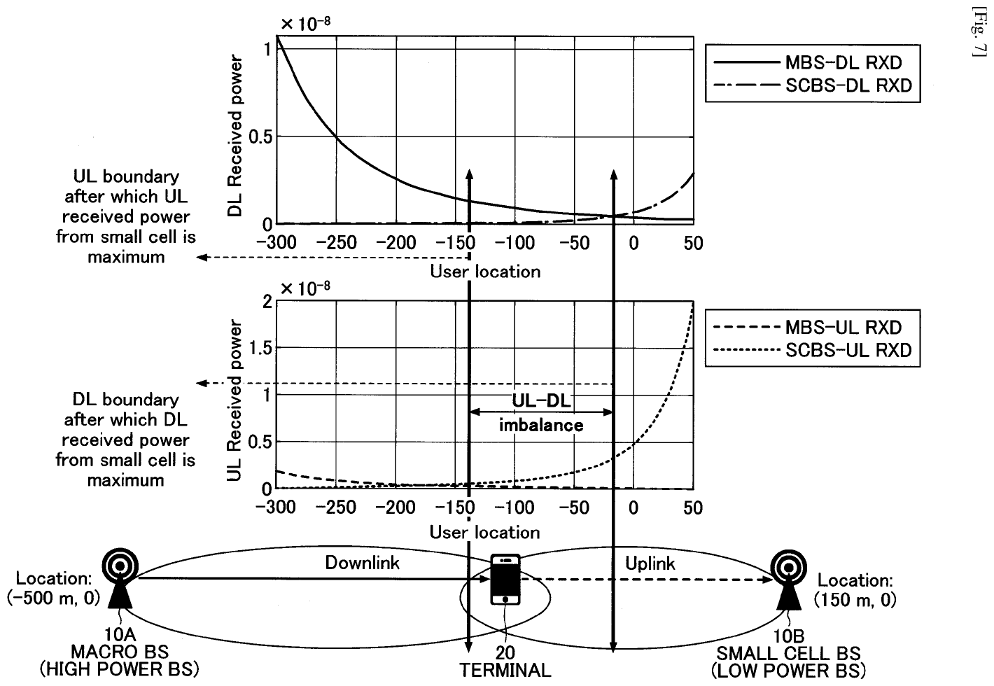

For example, each of the macro cell base station 10A, the small cell base station 10B, the terminal 20, and the RIS 30 may function as a computer for executing a process according to the embodiments. FIG. 6 is a diagram illustrating an example of the hardware configuration of each of the macro cell base station 10A, the small cell base station 10B, the terminal 20, and the RIS 30. Each device of the macro cell base station 10A, the small cell base station 10B, the terminal 20, and the RIS 30 may be physically configured as a computer device having a drive device 100, an auxiliary storage device 102, a memory device 103, a CPU 104, an interface device 105, and the like. The drive device 100, the auxiliary storage device 102, the memory device 103, the CPU 104, the interface device 105, and the like are mutually connected by a bus B.

In a computer device, a program for implementing processing is provided by a recording medium 101, such as a compact disc read-only memory (CD-ROM). When the recording medium 101 storing a program is set in the drive device 100, the program is installed in the auxiliary storage device 102 from the recording medium 101 through the drive device 100. However, the installation of the program need not be performed by using the recording medium 101, and the program may be downloaded from another computer via a network. The auxiliary storage device 102 stores the installed program and stores necessary files, data, and the like.

The memory device 103 reads out a program from the auxiliary storage device 102 and stores the program when an instruction to start a program is issued. The CPU 104 executes the function of the computer device according to the program stored in the memory device 103. The interface device 105 is used as an interface for connecting to a network.

### UL-DL Imbalance

FIG. 7 is a diagram illustrating an example in which a terminal 20 is located between the macro cell base station 10A and the small cell base station 10B. It is assumed that the terminal 20 moves on a straight line connecting the macro cell base station 10A and the small cell base station 10B.

In this case, received power for receiving a downlink signal from the macro cell base station 10A by the terminal 20 is referred to as received power A. Received power for receiving a downlink signal from the small cell base station 10B by the terminal 20 is referred to as received power B. Received power for receiving an uplink signal from the terminal 20 by the macro cell base station 10A is referred to as received power C. Received power for receiving an uplink signal from the terminal 20 by the small cell base station 10B is referred to as received power C.

When the terminal 20 moves from a position close to the macro cell base station 10A to the small cell base station 10B, the following three states, i.e., state 1 to state 3 can be considered:

State 1: a state where the received power A is higher than or equal to the received power B and the received power C is higher than or equal to the received power D;

State 2: a state where the received power A is higher than or equal to the received power B and the received power C is lower than the received power D; and

State 3: a state where the received power A is lower than the received power B and the received power C is lower than the received power D.

In the case of the state 1, the received power A for the terminal 20 to receive the downlink signal from the macro cell base station 10A is higher than or equal to the received power B for the terminal 20 to receive the downlink signal from the small cell base station 10B. Accordingly, in the case of the state 1, it is efficient for the terminal 20 to establish a downlink connection with the macro cell base station 10A.

In the case of the state 1, the received power C for the macro cell base station 10A to receive the uplink signal from the terminal 20 is higher than or equal to the received power D for the small cell base station 10B to receive the uplink signal from the terminal 20. Accordingly, in the case of the state 1, it is efficient for the terminal 20 to establish an uplink connection with the macro cell base station 10A.

Namely, in the case of the state 1, it is efficient for the terminal 20 to establish a connection with the macro cell base station 10A in the uplink and the downlink.

In the case of the state 3, the received power A for the terminal 20 to receive the downlink signal from the macro cell base station 10A is lower than the received power B for the terminal 20 to receive the downlink signal from the small cell base station 10B. Accordingly, in the case of the state 3, it is efficient for the terminal 20 to establish a downlink connection with the small cell base station 10B.

In the case of the state 3, the received power C for the macro cell base station 10A to receive the uplink signal from the terminal 20 is lower than the received power D for the small cell base station 10B to receive the uplink signal from the terminal 20. Accordingly, in the case of the state 3, it is efficient for the terminal 20 to establish an uplink connection with the small cell base station 10B.

Namely, in the case of the state 3, it is efficient for the terminal 20 to establish a connection with the small cell base station 10B in the uplink and the downlink.

In the case of the state 2, the received power A for the terminal 20 to receive the downlink signal from the macro cell base station 10A is higher than or equal to the received power B for the terminal 20 to receive the downlink signal from the small cell base station 10B. Accordingly, in the case of the state 2, it is efficient for the terminal 20 to establish a downlink connection with the macro cell base station 10A.

In the case of the state 2, the received power C for the macro cell base station 10A to receive the uplink signal from the terminal 20 is lower than the received power D for the small cell base station 10B to receive the uplink signal from the terminal 20. Accordingly, in the case of the state 2, it is efficient for the terminal 20 to establish an uplink connection with the small cell base station 10B.

### DUDe

As in the state 2, a state in which the received power from the macro cell base station 10A is high in the downlink and the received power at the small cell base station 10B is high in the uplink is called UL-DL imbalance. In the case of UL-DL imbalance, Downlink and Uplink Decoupling (DUDe) to separate UL and DL can be applied as a way to increase communication efficiency.

DUDe is a method to enhance a throughput by independently selecting a downlink source base station and an uplink destination base station in a network where multiple types of base stations exist.

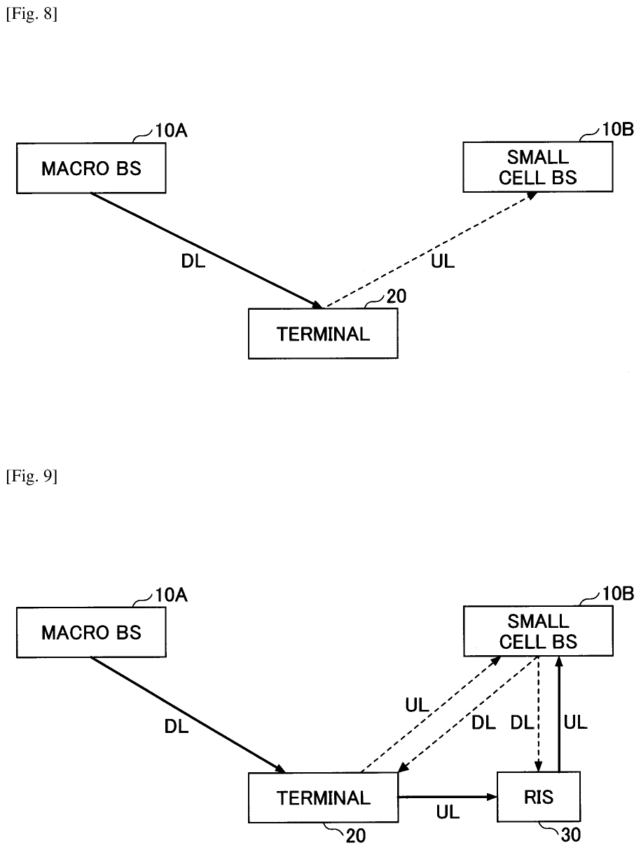

FIG. 8 is a diagram illustrating an example in which the terminal 20 communicates with the macro cell base station 10A and the small cell base station 10B by applying the DUDe method. For example, the terminal 20 may configure dual connectivity between the macro cell base station 10A and the small cell base station 10B, and, subsequently, the terminal 20 may communicate with the macro cell base station 10A and the small cell base station 10B by applying the DUDe method by changing a radio bearer configuration.

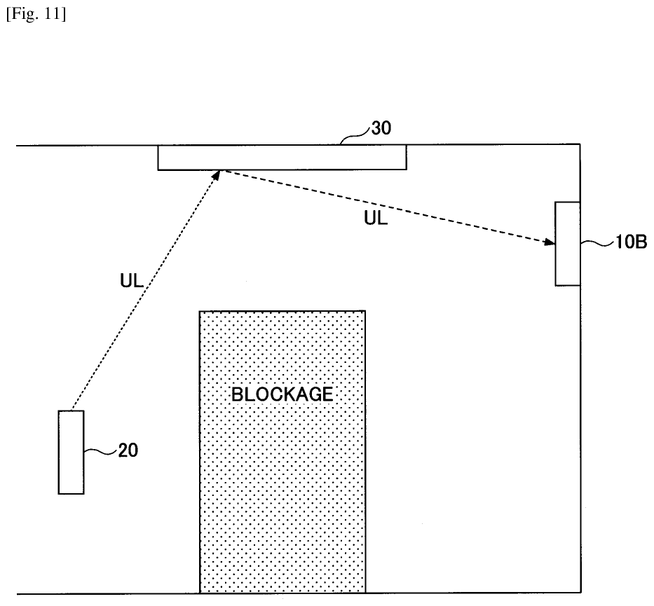

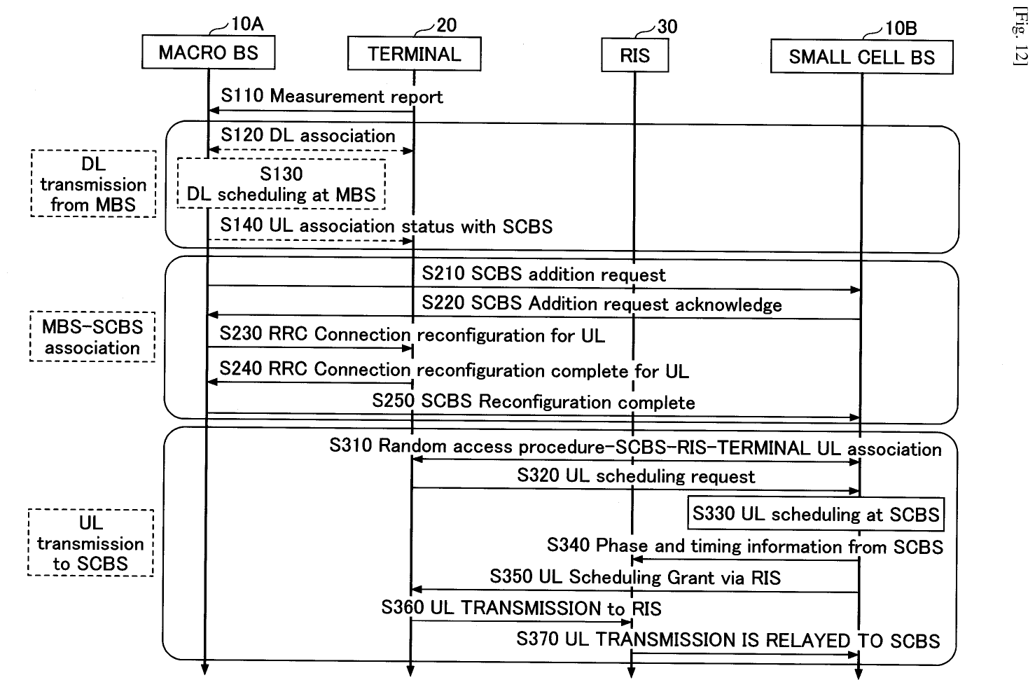

Here, a situation is assumed where the DUDe is applied to a space in which a large shield moves quasi-statically or dynamically, such as a space in a factory or a store room. For example, as illustrated in FIG. 11, supposed that a blockage is placed between the terminal 20 and the small cell base station 10B and line-of-sight communication is blocked. Furthermore, supposed that the RIS 30 is installed on a ceiling, and there is no blockage between the terminal 20 and the RIS 30, and between the RIS 30 and the small cell base station 10B.

In the example of FIG. 11, an incident wave from terminal 20 enters RIS 30 and is reflected by RIS 30. In this case, the received power of the uplink signal from the terminal 20 at the small cell base station 10B can be optimized (maximized) by adjusting the propagation direction of the reflected wave by the RIS 30. Additionally or alternatively, by changing the travelling direction of the reflected wave by the RIS 30, the small cell base station 10B for communicating with the terminal can be switched to another small cell base station 10B.

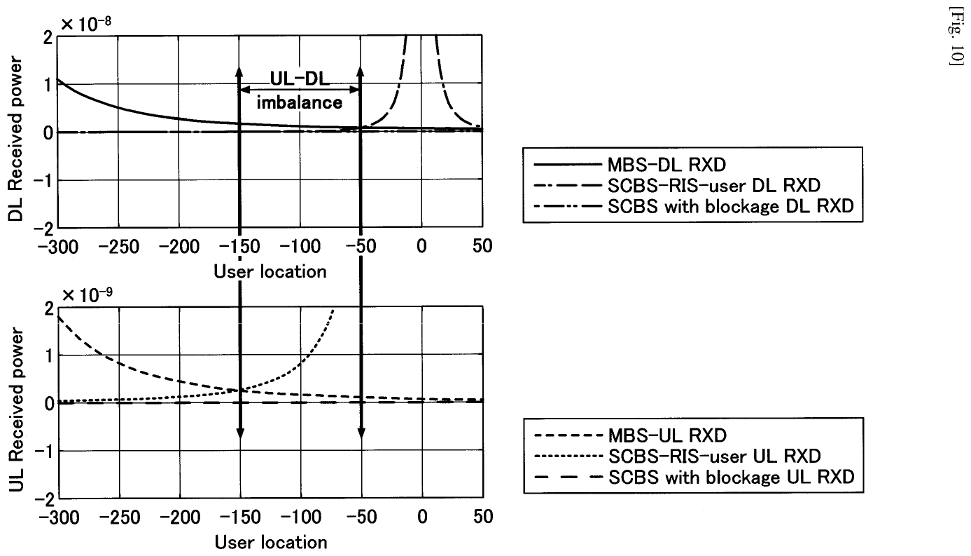

FIG. 9 is a diagram illustrating an example where the terminal 20 communicates with the macro cell base station 10A and the small cell base station 10B by applying a DUDe method. In the example of FIG. 9, the uplink communication between the terminal 20 and the small cell base station 10B is relayed by the RIS 30. In the example of FIG. 9, as illustrated in FIG. 11, when the RIS 30 reflects an incident wave from the terminal 20, the RIS 30 controls the reflection direction of the reflected wave in response to an instruction signal from the small cell base station 10B. The RIS 30 may control the reflection direction of the reflected wave so that the received power of the uplink signal from the terminal 20 (the reflected wave from the RIS 30) is optimized (maximized) at the small cell base station 10B. Additionally or alternatively, the RIS 30 may optimize the uplink communication by switching the small cell base station 10B for communicating the terminal 20 to another small cell base station 10B by controlling the reflection direction of the reflected wave.

For example, suppose that the RIS 30 can select one of a direction 1, direction 2, . . . , and a direction n, as the reflection direction of the reflected wave. The small cell base station 10B instructs the RIS 30 to reflect a predetermined reference signal from the terminal 20 at a timing 1, a timing 2, . . . , and a timing n, in the direction 1, the direction 2, . . . , and the direction n, respectively. The small cell base station 10B compares the received power value 1, the received power value 2, . . . , and the received power value n of the reference signal received at the timing 1, the timing 2, . . . , and the timing n, respectively, and the small cell base station 10B may indicates, to the RIS 30, a direction corresponding to the maximum received power value from among the received power values.

As another example, suppose that another small cell base station 10B is located in the vicinity of the small cell base station 10B communicating with the terminal 20. It is assumed that the small cell base station 10B and the another small cell base station 10B can communicate through an X2 interface. The small cell base station 10B communicating with the terminal 20 instructs the RIS 30 to reflect a predetermined reference signal from the terminal 20 at a timing 1, a timing 2, . . . , and a timing n, in the direction 1, the direction 2, . . . , and the direction n, respectively. The small cell base station 10B compares the received power value 1A, the received power value 2A, . . . , and the received power value nA of the reference signal received by the small cell base station 10B at the timing 1, the timing 2, . . . , and the timing n, respectively, and the received power value 1B, the received power value 2B, . . . , and the received power value nB of the reference signal received by the another small cell base station 10B at the timing 1, the timing 2, . . . , and the timing n, respectively, and the small cell base station 10B identifies the maximum received power value from among the received power value 1A, the received power value 2A, . . . , and the received power value nA and the received power value 1B, the received power value 2B, . . . , and the received power value nB.

If the small cell base station 10B itself receives the reference signal corresponding to the identified maximum received power value, the small cell base station 10B may maintain the destination of the communication with the terminal 20 to be the small cell base station 10B itself, and the small cell base station 10B may indicate the direction corresponding to the maximum received power value to the RIS 30. If the another small cell base station 10B receives the reference signal corresponding to the identified maximum received power value, the small cell base station 10B may indicate the direction corresponding to the maximum received power value to the RIS 30, and the small cell base station 10B may instruct the terminal 20 to change the destination of the communication to the another small cell base station 10B. In the above-described example, it is assumed that two small cell base stations 10B are located in the vicinity of the terminal 20. However, the embodiments of the present invention are not limited to this example. For example, three or more small cell base stations 10B may be located in the vicinity of the terminal 20.

FIG. 10 is a diagram illustrating an example of UL performance in a case where the RIS is applied to UL of the DUDe. As described above, the received power of the uplink signal from the terminal 20 at the small cell base station 10B can be optimized (maximized) by relaying the communication between the terminal 20 and the small cell base station 10B by the RIS 30, and by controlling the reflection direction by the RIS 30 of the carrier wave for carrying the signal from the terminal 20. In the example of FIG. 10, compared to the example of FIG. 7, the received power of the uplink signal from the terminal 20 at the small cell base station 10B is higher in the case of the UL-DL imbalance.

As described above, when the RIS is applied to UL of the DUDe, the terminal 20 can be always connected to a best base station in uplink and downlink. In particular, in a highly blocking environment, the UL traffic can be offloaded to an optimum small cell base station 10B in the vicinity of the terminal 20. The overall DL and UL communication rates of the terminal 20 placed in the blocking environment (and the region in which UL-DL imbalance occurs) can be enhanced, and, thus, the system throughput can be effectively enhanced. Note that the received power may be calculated based on the free space path loss.

FIG. 12 is a flowchart illustrating an example of a procedure executed in the radio communication system.

At step S110, the macro cell base station 10A receives a measurement report from the terminal 20. The measurement report includes information indicating the received power values of a signal from base stations (including the macro cell base station 10A and the small cell base station 10B) located in the vicinity of the terminal 20.

At step S120, communication between the macro cell base station 10A and the terminal 20 is configured. At step S130, the macro cell base station 10A schedules downlink communication to the terminal 20.

In response to detecting that the measurement report received by the macro cell base station 10A at step S110 indicates that the received power value from the small cell base station 10B is greater than a predetermined threshold value, the macro cell base station 10A determines to establish uplink communication between the terminal 20 and the small cell base station 10B. At step S140, the macro cell base station 10A transmits, to the terminal 20, a notification that the uplink communication between the terminal 20 and the small cell base station 10B is to be established.

Subsequently, at step S210 of FIG. 12, the macro cell base station 10A transmits, to the small cell base station 10B, a request to add the small cell base station 10B (SCBC addition request). At step S220, the small cell base station 10B transmits a positive acknowledgement to the request to add the small cell base station 10B (Small Cell Base Station (SCBS) Addition request acknowledgement).

At step S220, in response to receiving the positive acknowledgement to the request to add the small cell base station 10B, at step S230, the macro cell base station 10A transmits, to the terminal 20, Radio Resource Control (RRC) Connection reconfiguration for UL, which is configuration information for changing a configuration of the uplink communication by the terminal 20.

In response to receiving RRC Connection reconfiguration for UL in step S230, in step S240, the terminal 20 transmits RRC Connection reconfiguration complete for UL to the macro cell base station 10A. In step S240, in response to receiving the RRC Connection reconfiguration complete for UL, in step S250, the macro cell base station 10A transmits the SCSB Reconfiguration complete to the small cell base station 10B.

Subsequently, at step S310 of FIG. 12, a random access procedure is executed between the terminal 20 and the small cell base station 10B. At step S310, after the establishment of the uplink communication between the terminal 20 and the small cell base station 10B, the small cell base station 10B reconfigures the uplink communication between the terminal 20 and the small cell base station 10B, so that the uplink communication between the terminal 20 and the small cell base station 10B is relayed by the RIS 30.

At step S320, the terminal 20 transmits an uplink scheduling request to the small cell base station 10B. At step S330, the small cell base station 10B performs scheduling for the terminal 20. In this case, the small cell base station 10B may determine that the uplink communication with the terminal 20 is to be relayed by the RIS 30. Additionally, the small cell base station 10B may configure configuration information including information on a phase and a timing to be transmitted to the RIS 30, so that received power, at the small cell base station 10B, of a signal transmitted from the terminal 20 and reflected by the RIS 30 is to be optimized (maximized).

At step S340, the small cell base station 10B transmits, to the RIS 30, the configuration information including the phase and the timing to the RIS 30. The RIS 30 may adjust a direction for reflecting a carrier wave of the signal from the terminal 20 based on the received information on the phase and the timing. At step S350, the small cell base station 10B transmits a UL scheduling grant to the terminal 20. At this time, the small cell base station 10B may transmit the UL scheduling grant to the terminal 20 via the RIS 30. The UL scheduling grant may include information specifying a resource (a time and frequency domain resource) for transmitting a signal from the terminal 20 to the small cell base station 10B via the RIS 30.

Subsequently, at step S360, the terminal 20 performs a UL transmission to the RIS 30, and at step S370, the RIS 30 relays the UL transmission from the terminal 20 to the small cell base station 10B.

As described above, according to the embodiments, the overall communication rates of the DL and UL of the terminal 20 can be enhanced by applying the RIS 30 to the UL of the DUDe. Accordingly, the throughput of the radio communication system can be effectively increased.

### REFERENCE SIGNS LIST

10A macro cell base station
10B small cell base station
20 terminal
30 RIS
40 network
110 transmitter
120 receiving unit
130 controller
210 transmitter
220 receiver
230 controller
310 transmitter
320 receiver
330 controller
340 element
100 drive device
101 recording medium
102 storage device
103 memory device
104 CPU
105 Interface device
B Bus

1. A terminal for communicating with a first base station and a second base station, the terminal comprising:
a receiver that receives a first downlink signal from the first base station and a second downlink signal from the second base station;
a transmitter that transmits a first uplink signal to the first base station and a second uplink signal to the second base station; and
a processor that establishes a downlink connection with the first base station and an uplink connection with the second base station, in response to detecting that first received power of the first downlink signal in the terminal is higher than second received power of the second downlink signal in the terminal, and that third received power of the first uplink signal in the first base station is lower than or equal to fourth received power of the second uplink signal in the second base station,
wherein, upon detecting that the receiver receives an instruction signal from the second base station, the processor changes the uplink connection with the second base station to an uplink connection with the second base station via a relay device.

2. The terminal according to claim 1, wherein the relay device is a Reconfigurable Intelligent Surface (RIS) including a plurality of reflection elements, the RIS being capable of changing a traveling direction of a reflection wave.

3. The terminal according to claim 1, wherein transmitter transmits, to the second base station, a scheduling request for an uplink transmission, and
wherein the receiver receives, from the second base station, scheduling information for the uplink transmission, the scheduling information including configuration information on a phase or a transmission timing for the uplink transmission.

4. The terminal according to claim 3, wherein the transmitter transmits an uplink signal to the second base station via the relay device based on the scheduling information for the uplink transmission including the configuration information on the phase or the transmission timing received from the second base station.

5. A communication method executed by a terminal for communicating with a first base station and a second base station, the communication method comprising:
receiving a first downlink signal from the first base station and a second downlink signal from the second base station;
transmitting a first uplink signal to the first base station and a second uplink signal to the second base station; and
establishing a downlink connection with the first base station and an uplink connection with the second base station, in response to detecting that first received power of the first downlink signal in the terminal is higher than second received power of the second downlink signal in the terminal, and that third received power of the first uplink signal in the first base station is lower than or equal to fourth received power of the second uplink signal in the second base station,
wherein, upon detecting that an instruction signal is received from the second base station, the uplink connection with the second base station is changed to an uplink connection with the second base station via a relay device.

6. A radio communication system comprising:
a first base station;
a second base station;
a relay device; and
a terminal for communicating with the first base station and the second base station,
wherein the first base station includes
a first transmitter that transmits a first downlink signal to the terminal, and
a first receiver that receives a first uplink signal from the terminal,
wherein the second base station includes
a second transmitter that transmits a second downlink signal to the terminal, and
a second receiver that receives a second uplink signal from the terminal, and
wherein the terminal includes
a receiver that receives the first downlink signal from the first base station and the second downlink signal from the second base station;
a transmitter that transmits the first uplink signal to the first base station and the second uplink signal to the second base station; and
a processor that establishes a downlink connection with the first base station and an uplink connection with the second base station, in response to detecting that first received power of the first downlink signal in the terminal is higher than second received power of the second downlink signal in the terminal, and that third received power of the first uplink signal in the first base station is lower than or equal to fourth received power of the second uplink signal in the second base station,
wherein, upon detecting that the receiver receives an instruction signal from the second base station, the processor changes the uplink connection with the second base station to an uplink connection with the second base station via the relay device.
